(19) United States
(12) Patent Application Publication
(10) Pub. No.: US 2006/0053026 A1
(43) Pub. Date: Mar. 9, 2006

(54) MACHINE LUBRICANT AND COOLANT DISTRIBUTION SYSTEM

(75) Inventor: Wallace G. Boelkins, Grand Rapids, MI (US)

Correspondence Address: MCGARRY BAIR PC, 171 MONROE AVENUE, N.W., SUITE 600, GRAND RAPIDS, MI, 49503, US

(73) Assignee: UNIST, INC., Grand Rapids, MI (US)

(21) Appl. No.: 11/162,342

(22) Filed: Sep. 7, 2005

Related U.S. Application Data
(60) Provisional application No. 60/522,251, filed on Sep. 7, 2004.

(51) Int. Cl. G06Q 99/00

(52) U.S. Cl. 705/1; 184/6.14; 700/283

(57) ABSTRACT

A system provides for the delivery of lubricant or coolant to multiple machines simultaneously. The system comprises a single source of fluid where the single source is fluidly connected to a controller. The controller has a plurality of fluid connections to workstations. At least one fluid conduit extends between the controller and each workstation. Each workstation has means for applying the lubricant or coolant to a predetermined location. The locations are tools, workpieces, or drive components such as motors, bearings, gears, and the like. The lubricant or coolant is applied by an applicator, stream nozzle, or spray nozzle. The scrap material from the processing application is in condition for resale, instead of disposal.

### CROSS-REFERENCE TO RELATED APPLICATION

This application claims the benefit of U.S. provisional application Ser. No. 60/522,251, filed Sep. 7, 2004, which is incorporated herein in its entirety.

### FIELD OF THE INVENTION

The invention relates to a system for distributing lubricants and coolants to multiple machine workstations from a single source. More particularly, the invention relates to a controlled system for delivering metered quantities of lubricants and coolants, as needed, to machines, including their working parts, and workpieces in manufacturing or other industrial operations. In addition, the invention relates to a method of processing workpieces and recovering clean scrap material from the processes.

### DESCRIPTION OF THE RELATED ART

In industrial operations, particularly in cutting and machining operations on hard materials such as metals, it has long been recognized that it is highly desirable to apply liquid lubricants or coolants to the cutting tools or workpieces, and often to the motors and power tools as well, throughout duty cycles. Different processing operations involving tools and workpieces often have differing requirements for lubricants and coolants. Similarly, power tools and their moving parts, such as power motors, have differing requirements for coolants and lubricants.

It is common, for example, to deliver a continuous stream of coolant to a tool during a machining operation on a workpiece. One of the natural consequences of this process is a need to recover the coolant, filter any scrap particles machined from the workpiece, and otherwise store or recycle the coolant. Often the coolant is petroleum based so that the resulting coolant must be disposed of according to the requirements of hazardous waste disposal. Recycling and filtering of coolant and disposal of waste is very costly.

Sometimes coolants and lubricants must be delivered alternately to a workstation, and other times coolants and lubricants must be delivered simultaneously. The advent of automated equipment such as Computer Numeric Control (CNC) machining has added complexity to the problems of satisfactorily and timely delivering coolants and lubricants where needed.

It is also known to apply lubricants and coolants to advancing workpieces as they pass a particular location by contact with an applicator member. This is particularly advantageous for processing continuously advancing stock such as roll forming. An example of such a contact lubricator can be found in U.S. Pat. No. 5,849,086.

It is also known to apply lubricants and coolants in mist or “atomized” form by, for example, spraying from an appropriate nozzle. When applied in mist form, a comparable amount of fluid can cover a larger surface area of the target object than when it is applied as a stream, thus adding efficiency and economy to the lubricating/cooling process. Typically, the fluid is dry, i.e., light, water-based fluid from an oil concentrate that is delivered under pressure and combined with air at a nozzle to be sprayed on the workpiece.

Normally, because of the wide variety of machines, workstations, and processes, and their disparate requirements for delivery of coolants and lubricants, delivery systems are provided at the workstation, and controlled at the workstation. Such mechanisms can be found in commonly-owned U.S. Pat. Nos. 5,669,743, 5,542,498 and 6,213,412, all of which are incorporated herein by reference.

There remains a need for reliable and efficient system for delivering coolants and lubricants to different workstations involving different processes at lower cost and with a minimum of waste.

### SUMMARY OF THE INVENTION

According to the invention, a system is provided for delivering lubricants or coolants to multiple workstations. The system comprises a single or multiple source(s) of lubricants or coolants fluidly connected to a controller, and a plurality of fluid connections between the controller and multiple workstations. Each fluid connection is at least one fluid conduit that extends between the controller and a single workstation. Each workstation has means to apply the lubricant or coolant to a predetermined location in response to signals from the controller.

Preferably, the lubricants or coolants are near dry. The system is ideal where two workstations have different requirements for lubricants or coolants. The system is easily adapted for the single source to be pressurized. Preferably, the controller is programmable. Also, the system can include a compressed air source and a pneumatic connection between the compressed air reservoir and at least one workstation. In this manner, the flow of air via the pneumatic connection can be controlled by the controller.

In one aspect, a second fluid connection can be provided between the controller and at least one workstation. The workstation typically has a drive portion adapted to work on a workpiece. In accord with the invention, the controller controls the delivery of lubricants or coolants to the drive portion through one fluid connection, and to the workpiece through the second fluid connection. The workstation can have a slave controller to provide signals to the controller based on unique parameters of the workstation.

In another aspect, a system is provided to deliver lubricants or coolants to a single workstation having a drive portion adapted to work on a workpiece. The system comprises a source of lubricants or coolants fluidly connected to a controller, and at least two fluid connections between the controller and the workstation. The workstation has means to apply the lubricant or coolant to the drive portion through one fluid connection, and to the workpiece through the second fluid connection in response to signals from the controller.

Preferably, the lubricants or coolants are applied in minimal amounts, and may be in near dry form. Also, preferably, the source is pressurized. Typically, the controller will be programmable. The system can include a compressed air reservoir and a pneumatic connection between the compressed air reservoir and the workstation. Thus, the flow of air via the pneumatic connection can be controlled by the controller.

In another aspect of the invention, a method of recycling waste material from a processing operation is provided. The method includes the steps of providing a workpiece at a workstation, processing the workpiece, while using a near dry lubricant/coolant, into a finished workpiece and scrap, separating the scrap from the finished workpiece, and selling the scrap for market value.

### BRIEF DESCRIPTION OF THE DRAWINGS

In the drawings:

FIG. 1 is a schematic diagram showing a first embodiment of a system according to the invention.

FIG. 2 is a schematic diagram showing a second embodiment of the system according to the invention.

FIG. 3 is a schematic diagram showing one of the workstations of the system and FIG. 2.

FIG. 4 is a schematic diagram showing another of the workstations of the system in FIG. 2.

FIG. 5 is a perspective view of a portion of another of the workstations of the system in FIG. 2.

FIG. 6 is an illustration of the drilling machine at one of the workstations of the system in FIG. 2.

FIG. 7 is an illustration of a milling machine at one of the workstations of the system in FIG. 2.

FIG. 8 is an illustration of a screw machine at one of the workstations of the system in FIG. 2.

FIG. 9 is an illustration of a turning machine at one of the workstations of the system in FIG. 2.

FIG. 10 illustrates a method of processing and recovering scrap material according to the invention.

### DETAILED DESCRIPTION

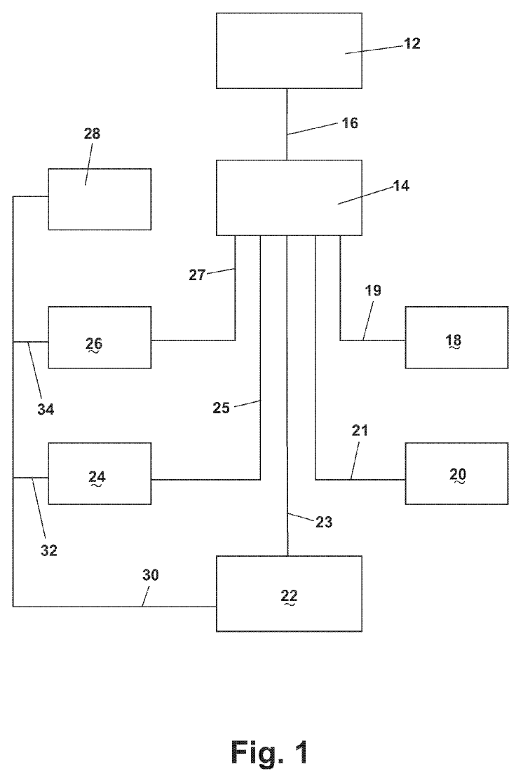

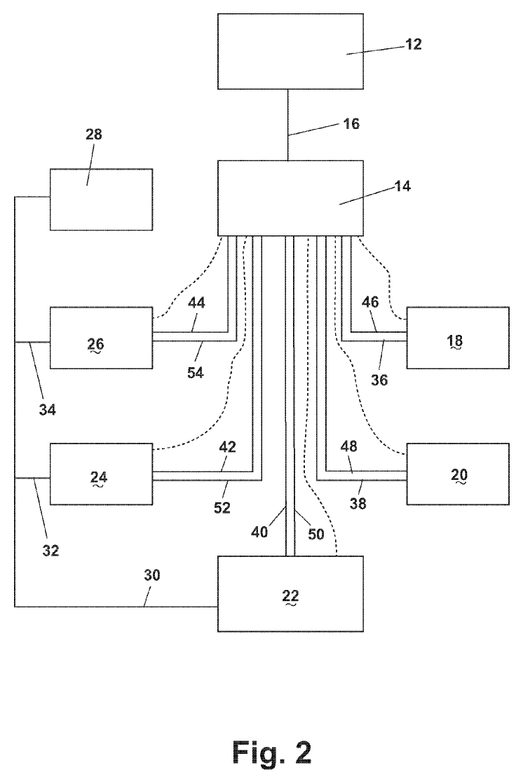

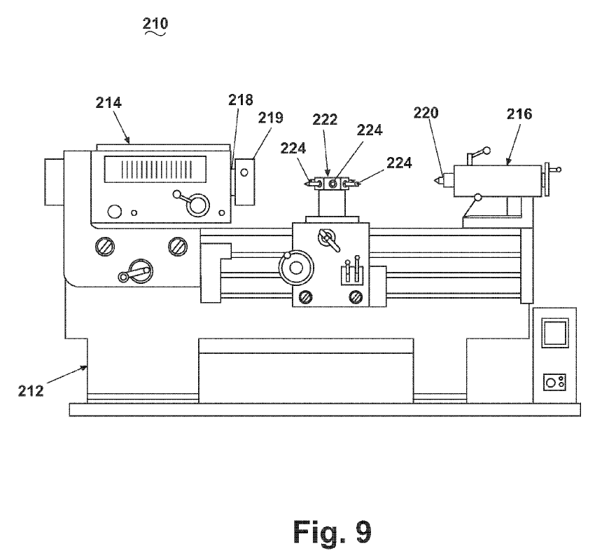

The lubricant and coolant delivery system according to the invention has three important aspects. First, FIG. 1 illustrates the general concept of the centralized delivery to a plurality of workstations. Second, FIGS. 2-8 illustrate in greater detail an exemplary delivery system with a variety of delivery modes. And third, FIG. 9 illustrates a method of workpiece processing and scrap material recovery that is achieved by implementation of a delivery system in accordance with the invention.

Looking now at the first aspect of the invention in FIG. 1, a lubricant and coolant delivery system 10 includes a fluid supply 12 fluidly connected to a controller 14 by a conduit 16. The fluid supply 12 will typically be a reservoir holding the desired lubricant or coolant. Preferably, the fluid supply 12 is pressurized. It is within the scope of the invention, however, for the fluid supply 12 to be unpressurized, in which case the conduit 16 can be pressurized by way of a pump (not shown), for example.

The controller 14 is ideally a programmable device capable of controlling the flow of lubricant or coolant to a plurality of workstations 18, 20, 22, 24, and 26. Each workstation is fluidly connected to the controller 14 by a corresponding conduit 19, 21, 23, 25, and 27. An example of a controller 14 that might be suitable for the present application can be found in commonly-owned U.S. Pat. No. 6,567,710, the entire disclosure of which is incorporated herein by reference.

It is contemplated that each of the workstations 18, 20, 22, 24, and 26 may be identical or may be different. It is further contemplated that there may be more or less workstations without departing from the scope of the invention. Each workstation, of course, might have different requirements for the specific localized delivery of lubricant or coolant. For example, workstation 18 may be a continuous processing application that would require a contact applicator of the type found in U.S. Pat. No. 5,849,086, the entire disclosure of which is incorporated herein by reference. Similarly, workstation 20 might be a tapping machine of the type incorporating a fluid dispensing system as disclosed in U.S. Pat. No. 5,669,743, the entire disclosure of which is incorporated herein by reference. Instead of having a separate reservoir of fluid in the localized dispensing unit, the conduit 21 will deliver fluid to the local dispensing unit at the workstation 20.

Workstations 22, 24, and 26 might be, for example, a drilling machine, a milling machine, a screw machine, and a turning machine respectively. It would be expected that the typical processes operated at workstations 22, 24, and 26 may require a pulse action mist lubrication system as disclosed in U.S. Pat. No. 5,542,498 or a spray head assembly as disclosed in U.S. Pat. No. 6,213,412. Both of these patents are incorporated herein by reference. For those deliveries at workstations requiring compressed air, an air reservoir 28 is provided with conduits directed to those workstations that may require compressed air. See, for example, conduits 30, 32, and 34. It will be understood that any or all of the workstations may require compressed air. In fact, it is within the scope of the invention for a conduit to connect the compressed air reservoir 28 to the controller 14, or for the flow of air to be controlled by the controller 14 and delivered through conduits adjacent to or coaxial with conduits 19, 21, 23, 25, and 27.

Looking now at FIGS. 2-8, where like numerals reflect like components to those illustrated in FIG. 1, a second aspect of the invention contemplates delivery of lubricant/coolant to drive portions of the workstations through one set of conduits 36, 38, 40, 42, and 44, and delivery of lubricant/coolant to tools and workpieces at the workstations through another set of conduits 46, 48, 50, 52, and 54. Moreover, each workstation 18, 20, 22, 24, and 26 will have one or more sensors (not shown) or slave controllers (not shown) that provide signals to the controller 14 (see dotted lines). Such signals will be electrical and can be transmitted over wires or wirelessly. The slave controllers will cooperate with the main controller to coordinate the flow of fluids through the conduits and the specific application of lubricant/coolant to a given point.

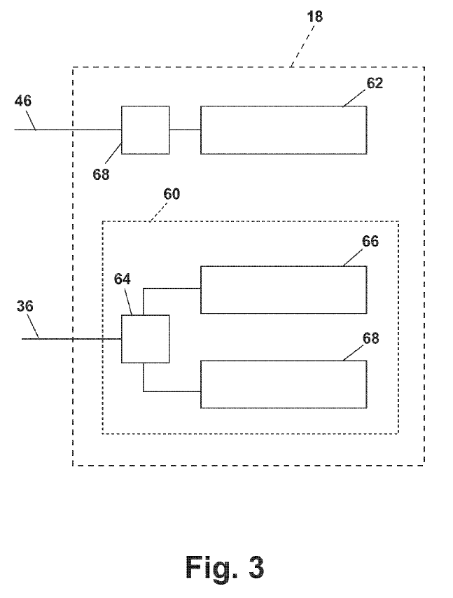

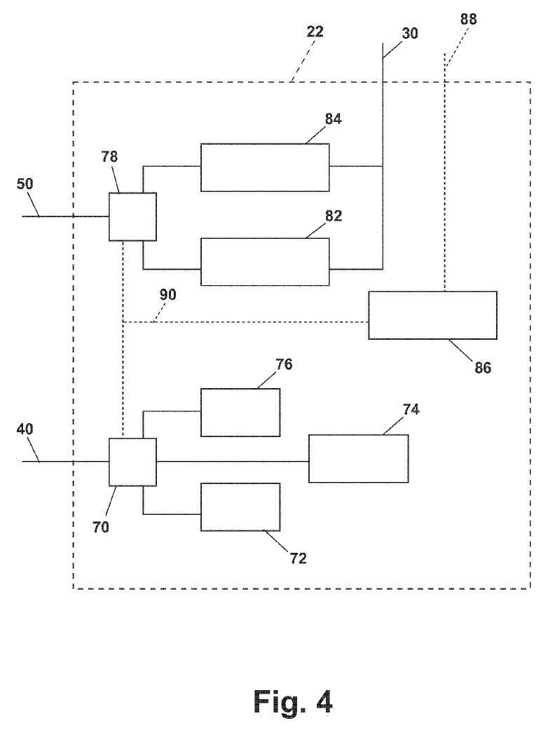

FIGS. 3 and 4 schematically illustrate the delivery of lubricant/coolant to exemplary workstations 18 and 22, respectively, following the examples assumed above. Workstation 18 comprises an apparatus 60 for driving a continuous workpiece through rollers, and a continuous applicator 62 for applying the lubricant/coolant to the workpiece. Fluid conducted through conduit 36 from the controller 14 enters a valve 64 which will control the delivery of lubricant to the roller bearings 66 and to the drive motor 68. Fluid directed through the conduit 46 from the controller 14 enters local valve 68 that locally controls delivery to the applicator 62. Because the applicator 62 provides a continuous stream, compressed air is not necessary and therefore there is no compressed air conduit to workstation 18.

Workstation 22, on the other hand, is a drill machine having a variety of tools and a variety of drive components, some of which are illustrated schematically in FIG. 4. Here, lubricant/coolant in conduit 40 is delivered to a local valve 70 where it is then directed to drive components such as drive bearings 72, drive motor 74, or tool turret bearings 76 for normal lubrication of those components, as needed. The lubricant/coolant in conduit 50 from the controller 14 is directed through a valve 78 to either or both a spray nozzle 84 for a drill and a spray nozzle 82 for the workpiece. It will be understood that there may be multiple spray nozzles for multiple tools and more than one spray nozzle for the workpiece. It will also be understood that the lubricant/coolant used for the drive components through conduit 40 might be different that the lubricant/coolant delivered through conduit 50. In such case, there may be two fluid supplies (not shown) that deliver the respective lubricant/coolants to the controller. Similarly there may a separate controller for each lubricant/coolant, as needed. In any event, as is commonly known, compressed air is provided through conduit 30 where it is combined with lubricant/coolant at the spray heads for distribution as a mist. Preferably, conduit 30 is coaxial with the conduit (40 or 50) that delivers the lubricant/coolant so that atomization occurs at the nozzle. But, it is within the scope of this invention for the conduit 30 to be separate from the conduit 40 or the conduit 50 delivering the lubricant/coolant. Either way, it is preferable for atomization to occur at the nozzle, although it has been known to atomize the lubricant/coolant upstream of the nozzle. The problem with the latter is that the lubricant/coolant may precipitate prior to reaching the nozzle. In any event, as is known from the prior art, the spray of lubricant/coolant can be pulsed or continuous, as described in the previously referenced and incorporated U.S. Pat. Nos. 5,542,498 and 6,213,412.

The preferred lubricant is a non-petroleum based oil, such as vegetable-based oils, preferably applied in minimal amounts. When the vegetable based oils are applied in atomized form, they form an essentially “near dry” lubricant. That is, the near dry lubricants leave very little to no residue on the scrap, unlike prior petroleum-based oil bath applications, which left the scrap with a heavy coat of oil. The minimal residue associated with near dry lubricants is partly related to the lower volumes of lubricant used as compared to prior lubricants and the tendency of the lubricant to evaporate when they contact the heated scrap. The application of the near dry lubricant through a mist or atomized forms aids in reducing the volume of lubricant. Also, the vegetable lubricant provides approximately double the friction reduction properties and has about double the heat capabilities before burning.

Also, a local controller 86 can communicate with the main controller 14 (not shown in FIG. 4) as shown by dotted line 88. Such control can be wired or wireless. Likewise, the local controller 86 provides relevant signals to the valves 70, 78 by way of signal path 90 to direct operation thereof, as needed. It will be understood that sensors at the drive components, tools and workpieces can transmit relevant signals either directly to the controller 14 or to the local controller 86 for retransmission to the controller 14. Processing of the signals can occur either at the local controller 86, the main controller 14 or both.

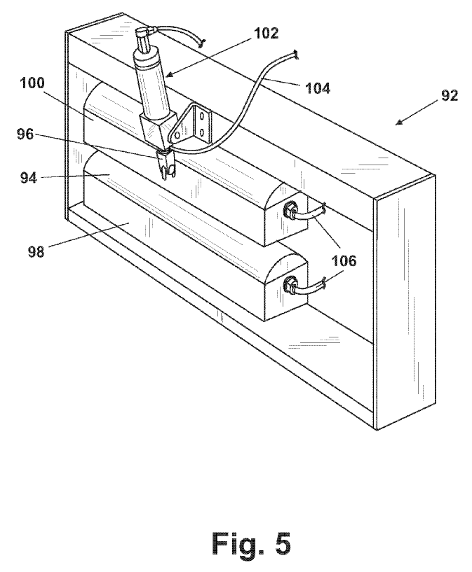

FIGS. 5-8 illustrate exemplary workstations showing the dual nature of the lubricant and coolant distribution system in accordance with the invention, where lubricant is directed to drive components as well as tooling and workpieces. In FIG. 5, a contact applicator 92 comprises a pair of vertically opposed, horizontally extending cylindrical rollers 94, 96 that are mounted in trough like housings 98, 100. The position of the upper row or 96 is adjustable by a pneumatic cylinder 102. Lubrication of this pneumatic cylinder 102 is provided from the controller (not shown) in accordance with the invention through conduit 104. Similarly, lubricant/coolant is provided to the rollers 94, 96 in accordance with the invention through conduits 106.

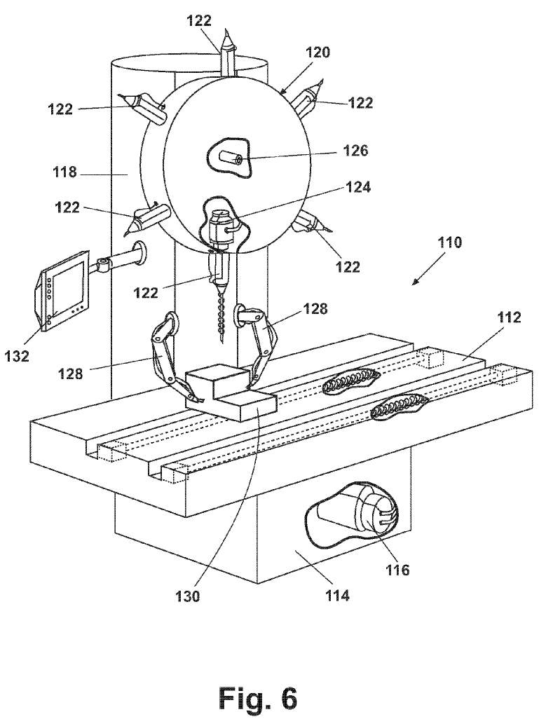

FIG. 6 illustrates a drill machine 110 that generally comprises a table 112 mounted for movement on a base 114. Movement of the table 112 relative to the base 114 is accomplished by drive motor 116. A column 118 disposed adjacent the table 112 carries a tool turret 120, rotatably mounted to the column. The tool turret 120 carries a plurality of drills 122, each drill being driven by a controllable motor 124. The tool 120 is typically mounted to the column on a shaft 126. Coolant supply tubes 128 extend from the column 118, and are adjustable relative to a workpiece 130. The drill machine 110 is controlled by a local controller 132. In accordance with the invention, lubricant will be provided to the drive components, including the drive motor 116, the controllable motor is 124, and the tool turret shaft 126 from a single source. Similarly, lubricant/coolant will be provided through coolant tubes 128 to the workpiece while the drilling process occurs. The lubricant/coolant will be provided from a remote, single source through the same delivery system as the lubricant provided to the drive components. Preferably, the lubricant/coolant provided to the workpiece 130 will be a pulsed, non petroleum-based mist.

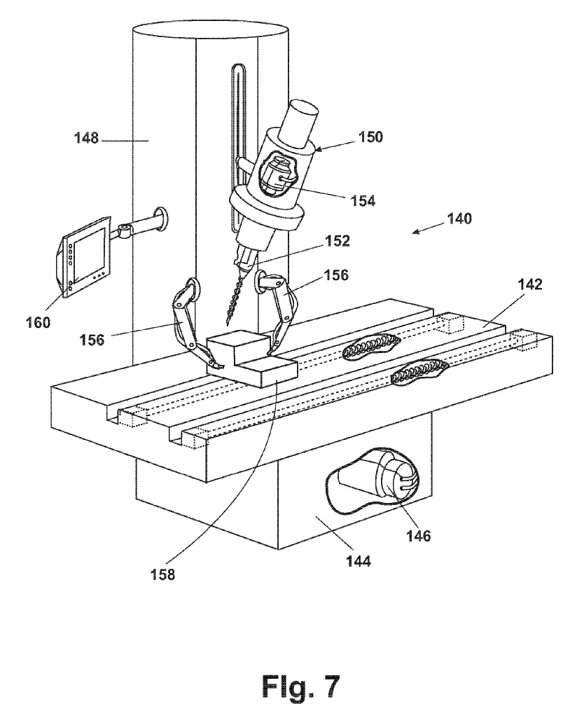

FIG. 7 illustrates a milling machine 140 that generally comprises a table 142 mounted for movement on a base 144. Movement of the table 142 relative to the base 144 is accomplished by drive motor 146. A column 148 disposed adjacent the table 142 carries a mill head 150, disposed for rotation on the column 148. The mill head 150 carries a cutting tool 152 that is driven by a motor 154. Coolant supply tubes 156 extend from the column 148, and are adjustable relative to a workpiece 158. The milling machine 140 is controlled by a local controller 160. In accordance with the invention, lubricant will be provided to the drive components, including the drive motor 146 and the mil motor 154 from a single source. Similarly, lubricant/coolant will be provided through coolant tubes 156 to the workpiece 158 while the milling process occurs. The lubricant/coolant will be provided from a remote, single source through the same delivery system as the lubricant provided to the drive components. Preferably, the lubricant/coolant provided to the workpiece 158 will be a pulsed, near dry mist.

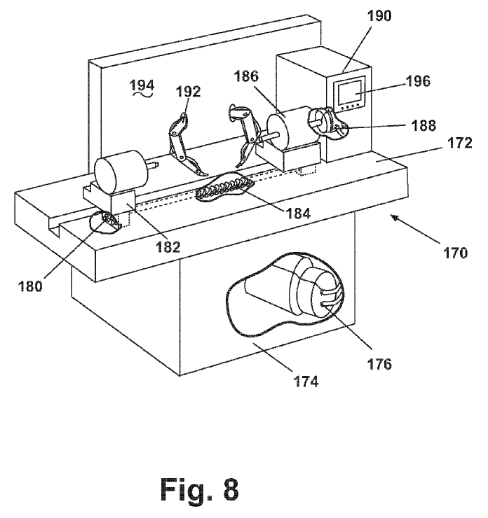

FIG. 8 illustrates a screw machine 170 that generally comprises a table 172 mounted to a base 174. A drive motor 176 in the base 174 is operatively connected to a gearbox 180 that drives a turret slide 182 on a carrier screw 184. A spindle 186 is driven by a drive motor 188 in a control drum 190. Coolant supply tubes 192 extend from a back wall 194, and are adjustable relative to a workpiece (not shown). The screw machine 170 is controlled by a local controller 196. In accordance with the invention, lubricant will be provided to the drive components, including the drive motor 176, gearbox 180, carrier screw 184, and drive motor 188 from a single source. Similarly, lubricant/coolant will be provided through coolant tubes 192 to the workpiece while the screw process occurs. The lubricant/coolant will be provided from a remote, single source through the same delivery system as the lubricant provided to the drive components. Preferably, the lubricant/coolant provided to the workpiece will be a pulsed, non petroleum-based mist.

FIG. 9 illustrates a turning machine 210 that generally comprises a bed 212 on which is fixedly mounted a head stock 214 and on which is moveably slidably mounted a tail stock 216. A spindle 218 with a chuck 219 is provided with the head stock 214. A quill 220 is provided with the tail stock 216. The workpiece is mounted between the spindle 218 and quill 220 for rotation in response to the rotation of the spindle. A turret 222 is slidably mounted to the bed 212 and mounts a variety of tools 224 for performing different machining operations be it cutting, facing or the like.

In accordance with the invention, lubricant will be provided to the drive components, including the spindle 218 from a single source. Similarly, lubricant/coolant will be provided through coolant tubes 192 to the workpiece while the turning process occurs. The lubricant/coolant will be provided from a remote, single source through the same delivery system as the lubricant provided to the drive components. Preferably, the lubricant/coolant provided to the workpiece will be a pulsed, non petroleum-based mist.

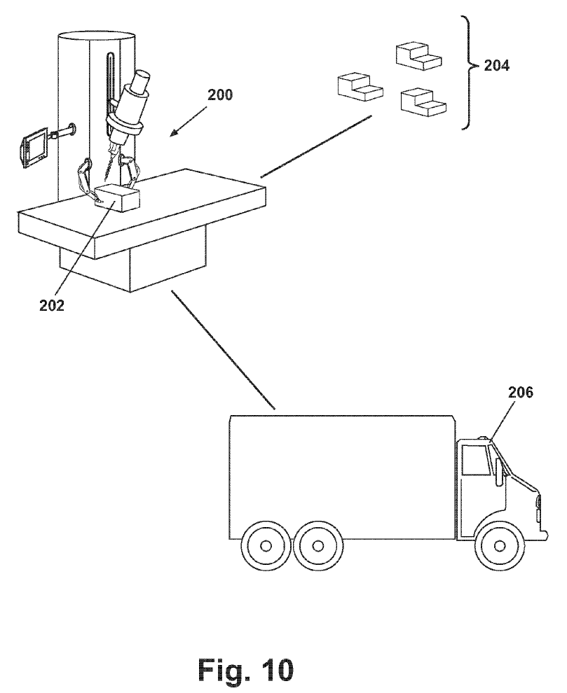

Looking now at FIG. 10, the overall method afforded by the instant invention using near dry lubricant/coolant is illustrated. Processing occurs at a workstation 200 on a workpiece 202. During processing, near dry lubricant/coolant comprising a non-petroleum-based fluid such as flaxseed oil is atomized to the spray head and delivered either continuously or pulsed to the tool and/or workpiece. Material that is removed from the workpiece during processing is collected and separated from the workpiece as scrap. Finished workpieces 204 are collected for further disposition such as further processing, assembly, or delivery to the customer. Scrap material is now in a condition to be resold 206 rather than disposed of as waste. Furthermore, because near dry lubricant/coolant is used in limited quantities, there is no need for a costly fluid recovery system, and no concern with hazardous waste.

While the invention has been specifically described in connection with certain specific embodiments thereof, it is to be understood that this is by way of illustration and not of limitation, and the scope of the appended claims should be construed as broadly as the prior art will permit.

What is claimed is:

1. A system for delivering lubricants or coolants to multiple workstations comprising a single source of lubricants or coolants fluidly connected to a controller, and a plurality of fluid connections between the controller and multiple workstations, each fluid connection being at least one fluid conduit extending between the controller and a single workstation, wherein each workstation has means to apply the lubricant or coolant to a predetermined location in response to signals from the controller.

2. The system according to claim 1 wherein the lubricants or coolants are near dry.

3. The system according to claim 1 wherein at least two workstations have different requirements for lubricants or coolants.

4. The system according to claim 1 wherein the single source is pressurized.

5. The system according to claim 1 wherein the controller is programmable.

6. The system according to claim 1 further comprising a compressed air reservoir and a pneumatic connection between the compressed air reservoir and at least one workstation, wherein the flow of air via the pneumatic connection is controlled by the controller.

7. The system according to claim 1 further comprising a second fluid connection between the controller and at least one workstation, wherein the at least one workstation has a drive portion adapted to work on a workpiece, and the controller controls the delivery of lubricants or coolants to the drive portion through one fluid connection, and to the workpiece through the second fluid connection.

8. The system according to claim 7 wherein the at least one workstation has a slave controller to provide signals to the controller based on unique parameters of the at least one workstation.

9. The system according to claim 7 wherein the lubricants or coolants are near dry.

10. A system for delivering lubricants or coolants to a single workstation having a drive portion adapted to work on a workpiece, the system comprising a source of lubricants or coolants fluidly connected to a controller, and at least two fluid connections between the controller and the workstation, wherein the workstation has means to apply the lubricant or coolant to the drive portion through one fluid connection, and to the workpiece through the second fluid connection in response to signals from the controller.

11. The system according to claim 10 wherein the lubricants or coolants are near dry.

12. The system according to claim 10 wherein the source is pressurized.

13. The system according to claim 10 wherein the controller is programmable.

14. The system according to claim 10 further comprising a compressed air reservoir and a pneumatic connection between the compressed air reservoir and the workstation, wherein the flow of air via the pneumatic connection is controlled by the controller.

15. A method of recycling waste material from a processing operation comprising:
providing a workpiece at a workstation,
processing the workpiece, while using a near dry lubricant/coolant, into a finished workpiece and scrap,
separating the scrap from the finished workpiece, and
selling the scrap without removing any residual lubricant/coolant on the scrap.

16. The method according to claim 15 wherein the scrap is sold at a price substantially equal to the market price for clean scrap.
